(19) United States
(12) Patent Application Publication
(10) Pub. No.: US 2026/0111215 A1
(43) Pub. Date: Apr. 23, 2026

(54) PROGRAM UPDATE METHOD AND APPARATUS, AND ELECTRONIC DEVICE AND STORAGE MEDIUM

(71) Applicant: SUZHOU METABRAIN INTELLIGENT TECHNOLOGY CO., LTD, Suzhou, Jiangsu (CN)

(72) Inventors: Xinglong WANG, Suzhou, Jiangsu (CN); Yanming SU, Suzhou, Jiangsu (CN); Qingwei ZHAI, Suzhou, Jiangsu (CN); Jinfeng LI, Suzhou, Jiangsu (CN); An WU, Suzhou, Jiangsu (CN); Baoyang LIU, Suzhou, Jiangsu (CN); Huatang BAN, Suzhou, Jiangsu (CN)

(21) Appl. No.: 19/120,159

(22) PCT Filed: Jun. 6, 2024
(86) PCT No.: PCT/CN2024/097869

§ 371 Date: Apr. 10, 2025

(30) Foreign Application Priority Data
Jul. 12, 2023 (CN) 202310852111.4

(51) Int. Cl. G06F 8/654

(52) U.S. Cl. CPC G06F 8/654

(57) ABSTRACT

The present application discloses a program updating method and apparatus, an electronic device, and a non-volatile readable storage medium, which relates to the technical field of computers. The method includes: migrating a new interruption processing program to a physical memory; acquiring upgradation parameters, and according to the upgradation parameters, determining a first position of the new interruption processing program in the physical memory and a second position of a to-be-upgraded interruption processing program in the physical memory; and migrating the new interruption processing program in the first position to the second position, to replace the to-be-upgraded interruption processing program. In the program updating method according to the present application, the new interruption processing program is migrated to the position of the to-be-upgraded interruption processing program in the physical memory, and because the new interruption processing program is in the physical memory, it becomes effective immediately after the upgrading program has exited, which realizes updating of the interruption processing program without restarting the system.

### CROSS-REFERENCE TO RELATED APPLICATION

The present application claims the priority of the Chinese patent application filed on Jul. 12, 2023 before the Chinese Patent Office with the application number of 202310852111.4 and the title of “PROGRAM UPDATE METHOD AND APPARATUS, AND ELECTRONIC DEVICE AND STORAGE MEDIUM”, which is incorporated herein in its entirety by reference.

### FIELD

The present application relates to the technical field of computers, and particularly relates to a program updating method and apparatus, an electronic device, and a non-volatile readable storage medium.

### BACKGROUND

The processor in a computer system usually has the interruption mechanism of a high-level permission. The BIOS (Basic Input Output System) and the OS (Operating System) enter a privileged interruption processing program by triggering high-level permission interruption. For example, when a firmware mirror image of the BIOS is being refreshed in the OS, in order to ensure the safety of the firmware mirror image, the OS cannot directly access the Flash memory of the BIOS. Therefore, it is required to trigger privileged interruption in the OS, wherein the interruption processing program of such interruption has the highest processor permission, and the Flash memory of the BIOS is updated by using that privileged code. The privileged interruption also may be used to perform fault diagnosis at the processor level, for example, in the privileged code, accessing the register of the processor to analyze system failures.

The privileged interruption processing program itself might be problematic, and once the privileged code that processes the high-level permission function has a problem, crashing might happen in the system. In the related art, the BIOS mirror image is written into the BIOS Flash by the OS or the BMC (Baseboard Management Controller), and, after the Flash writing has been completed, it is required to restart the system to cause the privileged code to become effective.

Therefore, to realize updating of the interruption processing program without restarting the system is a technical problem that a person skilled in the art requires solving.

### SUMMARY

An object of the present application is to provide a program updating method and apparatus, an electronic device, and a non-volatile readable storage medium, which realizes updating of the interruption processing program without restarting the system.

In order to achieve the above object, the present application provides a program updating method, wherein the method comprises:
migrating a new interruption processing program to a physical memory;
acquiring upgradation parameters, and according to the upgradation parameters, determining a first position of the new interruption processing program in the physical memory and a second position of a to-be-upgraded interruption processing program in the physical memory; and
migrating the new interruption processing program in the first position to the second position, to replace the to-be-upgraded interruption processing program.

In some embodiments of the present application, the step of migrating the new interruption processing program to the physical memory comprises:
migrating the new interruption processing program pre-stored in a magnetic-disk memory to the physical memory.

In some embodiments of the present application, the step of migrating the new interruption processing program to the physical memory comprises:
migrating the new interruption processing program to the first position in the physical memory.

In some embodiments of the present application, after the step of migrating the new interruption processing program to the physical memory, the method further comprises:
writing the upgradation parameters into a register of a processor.

In some embodiments of the present application, the step of acquiring the upgradation parameters comprises:
acquiring the upgradation parameters from the register of the processor.

In some embodiments of the present application, the upgradation parameters include the first position of the new interruption processing program in the physical memory, a code length of the new interruption processing program, and an interruption number of the to-be-upgraded interruption processing program.

In some embodiments of the present application, the step of, according to the upgradation parameters, determining the first position of the new interruption processing program in the physical memory and the second position of the to-be-upgraded interruption processing program in the physical memory comprises:
according to the upgradation parameters, determining the first position of the new interruption processing program in the physical memory; and
according to the interruption number of the to-be-upgraded interruption processing program among the upgradation parameters, determining the second position of the to-be-upgraded interruption processing program in the physical memory.

In some embodiments of the present application, the step of migrating the new interruption processing program in the first position to the second position comprises:
according to the code length of the new interruption processing program among the upgradation parameters, migrating the new interruption processing program in the first position to the second position.

In some embodiments of the present application, after the step of migrating the new interruption processing program in the first position to the second position, to replace the to-be-upgraded interruption processing program, the method further comprises:
in response to interruption corresponding to an interruption processing program being triggered, triggering a processor to execute the new interruption processing program in the second position.

In some embodiments of the present application, after the step of migrating the new interruption processing program in the first position to the second position, to replace the to-be-upgraded interruption processing program, the method further comprises:
migrating the new interruption processing program in the first position into a non-volatile memory.

In some embodiments of the present application, the step of migrating the new interruption processing program in the first position into the non-volatile memory comprises:
migrating the new interruption processing program in the first position into a flash memory of a Basic Input Output System.

In some embodiments of the present application, after the step of migrating the new interruption processing program in the first position into the flash memory of the Basic Input Output System, the method further comprises:
in response to a processor being restarted, in a process of starting-up of the Basic Input Output System, migrating the new interruption processing program in the non-volatile memory into the physical memory.

In some embodiments of the present application, the interruption processing program includes an interruption processing program having a highest processor permission.

In some embodiments of the present application, the step of migrating the new interruption processing program to the physical memory comprises:
by using an operating-system upgrading program, migrating the new interruption processing program to the physical memory.

In some embodiments of the present application, after the step of, by using the operating-system upgrading program, migrating the new interruption processing program to the physical memory, the method further comprises:
by using the operating-system upgrading program, writing the upgradation parameters into a register of a processor.

In some embodiments of the present application, after the step of, by using the operating-system upgrading program, writing the upgradation parameters into the register of the processor, the method further comprises:
by using the operating-system upgrading program, writing a predetermined interruption number into an interruption controller, whereby the interruption controller, after has identified the predetermined interruption number, starts up a privilege upgrading program.

In some embodiments of the present application, the step of acquiring the upgradation parameters, and according to the upgradation parameters, determining the first position of the new interruption processing program in the physical memory and the second position of the to-be-upgraded interruption processing program in the physical memory comprises:
by using the privilege upgrading program, acquiring the upgradation parameters from the register of the processor, and according to the upgradation parameters, determining the first position of the new interruption processing program in the physical memory and the second position of the to-be-upgraded interruption processing program in the physical memory.

In some embodiments of the present application, the step of migrating the new interruption processing program in the first position to the second position, to replace the to-be-upgraded interruption processing program comprises:
by using the privilege upgrading program, migrating the new interruption processing program in the first position to the second position, to replace the to-be-upgraded interruption processing program.

In some embodiments of the present application, after the step of, by using the privilege upgrading program, migrating the new interruption processing program in the first position to the second position, to replace the to-be-upgraded interruption processing program, the method further comprises:
by using the privilege upgrading program, migrating the new interruption processing program in the first position into a non-volatile memory.

In order to achieve the above object, the present application provides a program updating apparatus, wherein the apparatus comprises:

a first migrating module configured for migrating a new interruption processing program to a physical memory;
a determining module configured for acquiring upgradation parameters, and according to the upgradation parameters, determining a first position of the new interruption processing program in the physical memory and a second position of a to-be-upgraded interruption processing program in the physical memory; and
a second migrating module configured for migrating the new interruption processing program in the first position to the second position, to replace the to-be-upgraded interruption processing program.

In some embodiments of the present application, the first migrating module is particularly configured for:
migrating the new interruption processing program pre-stored in a magnetic-disk memory to the physical memory.

In some embodiments of the present application, the first migrating module is particularly configured for:
migrating the new interruption processing program to the first position in the physical memory.

In some embodiments of the present application, the apparatus further comprises:
a first writing module configured for writing the upgradation parameters into a register of a processor.

In some embodiments of the present application, the determining module is particularly configured for:
acquiring the upgradation parameters from the register of the processor, and according to the upgradation parameters, determining the first position of the new interruption processing program in the physical memory and the second position of the to-be-upgraded interruption processing program in the physical memory.

In some embodiments of the present application, the upgradation parameters include the first position of the new interruption processing program in the physical memory, a code length of the new interruption processing program, and an interruption number of the to-be-upgraded interruption processing program.

In some embodiments of the present application, the determining module is particularly configured for:
acquiring upgradation parameters;
according to the upgradation parameters, determining the first position of the new interruption processing program in the physical memory; and
according to the interruption number of the to-be-upgraded interruption processing program among the upgradation parameters, determining the second position of the to-be-upgraded interruption processing program in the physical memory.

In some embodiments of the present application, the second migrating module is particularly configured for:
according to the code length of the new interruption processing program among the upgradation parameters, migrating the new interruption processing program in the first position to the second position.

In some embodiments of the present application, the apparatus further comprises:
a triggering module configured for, in response to interruption corresponding to an interruption processing program being triggered, triggering a processor to execute the new interruption processing program in the second position.

In some embodiments of the present application, the apparatus further comprises:
a third migrating module configured for migrating the new interruption processing program in the first position into a non-volatile memory.

In some embodiments of the present application, the third migrating module is particularly configured for:
migrating the new interruption processing program in the first position into a flash memory of a Basic Input Output System.

In some embodiments of the present application, the apparatus further comprises:
a fourth migrating module configured for, in response to a processor being restarted, in a process of starting-up of the Basic Input Output System, migrating the new interruption processing program in the non-volatile memory into the physical memory.

In some embodiments of the present application, the interruption processing program includes an interruption processing program having a highest processor permission.

In some embodiments of the present application, the first migrating module is particularly configured for:
by using an operating-system upgrading program, migrating the new interruption processing program to the physical memory.

In some embodiments of the present application, the first writing module is particularly configured for:
by using the operating-system upgrading program, writing the upgradation parameters into a register of a processor.

In some embodiments of the present application, the apparatus further comprises:
a second writing module configured for, by using the operating-system upgrading program, writing a predetermined interruption number into an interruption controller, whereby the interruption controller, after has identified the predetermined interruption number, starts up a privilege upgrading program.

In some embodiments of the present application, the determining module is particularly configured for:
by using the privilege upgrading program, acquiring the upgradation parameters from the register of the processor, and according to the upgradation parameters, determining the first position of the new interruption processing program in the physical memory and the second position of the to-be-upgraded interruption processing program in the physical memory.

In some embodiments of the present application, the second migrating module is particularly configured for:
by using the privilege upgrading program, migrating the new interruption processing program in the first position to the second position, to replace the to-be-upgraded interruption processing program.

In some embodiments of the present application, the third migrating module is particularly configured for:
by using the privilege upgrading program, migrating the new interruption processing program in the first position into a non-volatile memory.

In order to achieve the above object, the present application provides an electronic device, wherein the electronic device comprises:
a memory configured for storing a computer program; and
a processor configured for, when executing the computer program, implementing the steps of the program updating method stated above.

In order to achieve the above object, the present application provides a non-volatile readable storage medium, wherein the non-volatile readable storage medium stores a computer program, and the computer program, when executed by a processor, implements the steps of the program updating method stated above.

It can be known from the above solutions that the program updating method according to the present application comprises: migrating a new interruption processing program to a physical memory; acquiring upgradation parameters, and according to the upgradation parameters, determining a first position of the new interruption processing program in the physical memory and a second position of a to-be-upgraded interruption processing program in the physical memory; and migrating the new interruption processing program in the first position to the second position, to replace the to-be-upgraded interruption processing program.

The advantageous effect of the present application is as follows. In the program updating method according to the present application, the new interruption processing program is migrated to the position of the to-be-upgraded interruption processing program in the physical memory, and because the new interruption processing program is in the physical memory, it becomes effective immediately after the upgrading program has exited, which realizes updating of the interruption processing program without restarting the system. The present application further discloses a program updating apparatus, an electronic device, and a non-volatile readable storage medium, which also may realize the above-described technical effect.

It should be understood that the above general description and the following detailed description are merely exemplary, and cannot limit the present application.

### BRIEF DESCRIPTION OF THE DRAWINGS

In order to more clearly illustrate the technical solutions of the embodiments of the present application or the prior art, the figures that are required to describe the embodiments or the prior art will be briefly described below. Apparently, the figures that are described below are merely embodiments of the present application, and a person skilled in the art can obtain other figures according to these figures without paying creative work. The drawings are intended to provide a further understanding of the present disclosure, and constitute part of the description. The drawings are intended to interpret the present disclosure together with the following particular embodiments, and do not function to limit the present disclosure. In the drawings:

FIG. 1 is a flow chart of a program updating method according to some illustrative embodiments of the present application;

FIG. 2 is a flow chart of another program updating method according to some illustrative embodiments of the present application;

FIG. 3 is a structural diagram of a computer system according to some illustrative embodiments of the present application;

FIG. 4 is a structural diagram of a program updating apparatus according to some illustrative embodiments of the present application; and

FIG. 5 is a structural diagram of an electronic device according to some illustrative embodiments of the present application.

### DETAILED DESCRIPTION

The technical solutions according to the embodiments of the present application will be clearly and completely described below with reference to the drawings according to the embodiments of the present application. Apparently, the described embodiments are merely certain embodiments of the present application, rather than all of the embodiments. All of the other embodiments that a person skilled in the art obtains on the basis of the embodiments of the present application without paying creative work fall within the protection scope of the present application. In addition, in the embodiments of the present application, “first”, “second” and so on are intended to distinguish similar objects, and are not necessarily used to describe a particular order or sequence.

An embodiment of the present application discloses a program updating method, which realizes updating of the interruption processing program without restarting the system.

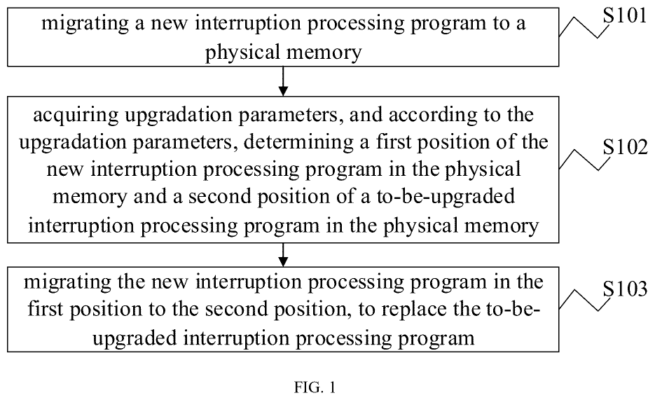

Referring to FIG. 1, FIG. 1 is a flow chart of a program updating method according to some illustrative embodiments of the present application. As shown in FIG. 1, the method comprises:
S101: migrating a new interruption processing program to a physical memory.

The purpose of the present embodiment is to realize updating of the interruption processing program. The interruption processing program according to the present embodiment may be an interruption processing program having the highest processor permission, i.e., a privileged interruption processing program. In this step, the new interruption processing program is migrated to the physical memory.

As some alternative embodiments of the present application, the step of migrating the new interruption processing program to the physical memory comprises:
migrating the new interruption processing program pre-stored in a magnetic-disk memory to the physical memory.

In a particular implementation, the user may pre-store the new interruption processing program in the magnetic-disk memory, and the processor migrates the new interruption processing program pre-stored in the magnetic-disk memory to the physical memory.

As some alternative embodiments of the present application, the step of migrating the new interruption processing program to the physical memory comprises:
migrating the new interruption processing program to the first position in the physical memory.

In a particular implementation, the processor migrates the new interruption processing program saved in advance in the magnetic-disk memory by the user to a specific address position of the physical memory of the system, i.e., the first position.
S102: acquiring upgradation parameters, and according to the upgradation parameters, determining a first position of the new interruption processing program in the physical memory and a second position of a to-be-upgraded interruption processing program in the physical memory.

As some alternative embodiments of the present application, after the step of migrating the new interruption processing program to the physical memory, the method further comprises:
writing the upgradation parameters into a register of a processor.

In a particular implementation, the processor writes the upgradation parameters into the register, and the upgradation parameters may include the first position of the new interruption processing program in the physical memory, the code length of the new interruption processing program, and the interruption number of the to-be-upgraded interruption processing program. The interruption numbers and to-be-upgraded privileged programs correspond one to one, and are used to determine the position of the to-be-upgraded interruption processing program in the physical memory, i.e., the second position.

In this step, the upgradation parameters are acquired from the register of the processor, and according to the upgradation parameters, the first position of the new interruption processing program in the physical memory and the second position of the to-be-upgraded interruption processing program in the physical memory are determined.

As some alternative embodiments of the present application, the step of, according to the upgradation parameters, determining the first position of the new interruption processing program in the physical memory and the second position of the to-be-upgraded interruption processing program in the physical memory comprises:
according to the upgradation parameters, determining the first position of the new interruption processing program in the physical memory; and
according to the interruption number of the to-be-upgraded interruption processing program among the upgradation parameters, determining the second position of the to-be-upgraded interruption processing program in the physical memory.

In a particular implementation, the processor, according to the upgradation parameters, determines the first position of the new interruption processing program in the physical memory; and, according to the interruption number of the to-be-upgraded interruption processing program among the upgradation parameters, determines the second position of the to-be-upgraded interruption processing program in the physical memory.
S103: migrating the new interruption processing program in the first position to the second position, to replace the to-be-upgraded interruption processing program.

In this step, the new interruption processing program in the first position in the physical memory is migrated to the second position in the physical memory, so as to replace the to-be-upgraded interruption processing program in the second position in the physical memory with the new interruption processing program.

As some alternative embodiments of the present application, the step of migrating the new interruption processing program in the first position to the second position comprises:
according to the code length of the new interruption processing program among the upgradation parameters, migrating the new interruption processing program in the first position to the second position.

In a particular implementation, the processor, according to the upgradation parameters, determines the code length of the new interruption processing program, and, according to the code length, migrates the new interruption processing program to the second position in the physical memory.

Because the new interruption processing program is in the internal memory, it becomes effective immediately after the upgrading program has exited, and, subsequently, when the interruption corresponding to the interruption processing program is triggered in the operating system, the processor is triggered to execute the new interruption processing program. In other words, after the step of migrating the new interruption processing program in the first position to the second position, to replace the to-be-upgraded interruption processing program, the method further comprises: in response to interruption corresponding to an interruption processing program being triggered, triggering a processor to execute the new interruption processing program in the second position.

On the basis of the present embodiment, as some embodiments of the present application, after the step of migrating the new interruption processing program in the first position to the second position, to replace the to-be-upgraded interruption processing program, the method further comprises:
migrating the new interruption processing program in the first position into a non-volatile memory.

In a particular implementation, the new interruption processing program in the first position in the physical memory is migrated into the non-volatile memory, wherein the migration position is the position of the to-be-upgraded interruption processing program in the non-volatile memory. In other words, the interruption processing program in the non-volatile memory is replaced by the newest code, to realize non-volatile saving of the interruption processing program, i.e., capable of being saved in powering-down, to ensure that, subsequently, while the system is being started up, in the process of the starting-up of the BIOS, the new interruption processing program in the non-volatile memory is migrated into the physical memory. In other words, after the step of migrating the new interruption processing program in the first position into the flash memory of the Basic Input Output System, the method further comprises: in response to a processor being restarted, in a process of starting-up of the Basic Input Output System, migrating the new interruption processing program in the non-volatile memory into the physical memory.

As some alternative embodiments of the present application, the step of migrating the new interruption processing program in the first position into the non-volatile memory comprises: migrating the new interruption processing program in the first position into a flash memory of a Basic Input Output System. In a particular implementation, the new interruption processing program is migrated into a BIOS Flash.

In the program updating method according to the embodiments of the present application, the new interruption processing program is migrated to the position of the to-be-upgraded interruption processing program in the physical memory, and because the new interruption processing program is in the physical memory, it becomes effective immediately after the upgrading program has exited, which realizes updating of the interruption processing program without restarting the system.

An embodiment of the present application discloses a program updating method. As compared with the above embodiments, the present embodiment further describes and optimizes the technical solutions. Particularly:

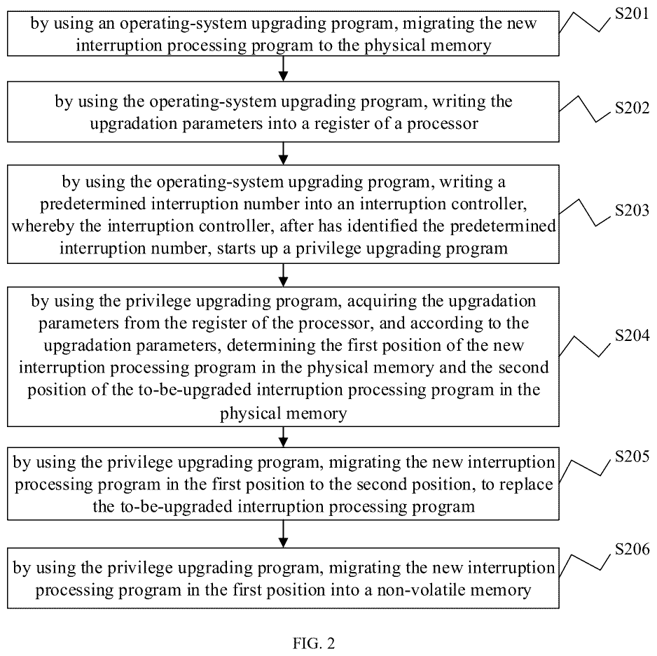

Referring to FIG. 2, FIG. 2 is a flow chart of another program updating method according to some illustrative embodiments of the present application. As shown in FIG. 2, the method comprises:
S201: by using an operating-system upgrading program, migrating the new interruption processing program to the physical memory.

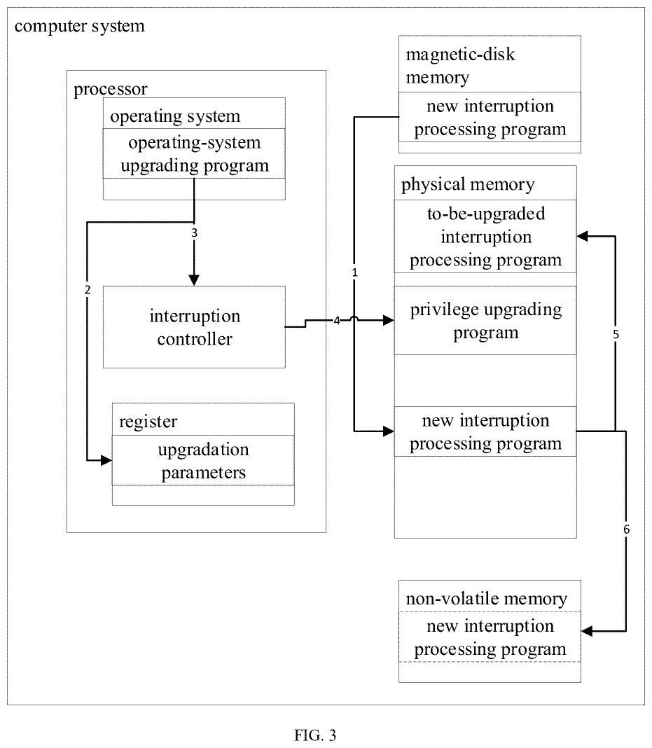

The present embodiment is applied in the computer system shown in FIG. 3. As shown in FIG. 3, the computer system comprises a processor, a magnetic-disk memory, a physical memory and a non-volatile memory. The processor comprises an operating system, an interruption controller and a register. The operating system operates an operating-system upgrading program. The register is used to store the upgradation parameters.

In the present embodiment, the operating-system upgrading program serves to initiate the updating process. Firstly, the operating-system upgrading program migrates the new interruption processing program saved in advance in the magnetic-disk memory by the user to a specific address position of the physical memory of the system, i.e., the first position, referring to 1 in FIG. 3.
S202: by using the operating-system upgrading program, writing the upgradation parameters into a register of a processor.

In this step, the operating-system upgrading program writes the upgradation parameters into the CPU (Central Processing Unit) register, referring to 2 in FIG. 3. The upgradation parameters may include the first position of the new interruption processing program in the physical memory, the code length of the new interruption processing program, and the interruption number of the to-be-upgraded interruption processing program. The interruption numbers and to-be-upgraded privileged programs correspond one to one, and are used to determine the position of the to-be-upgraded interruption processing program in the physical memory, i.e., the second position.
S203: by using the operating-system upgrading program, writing a predetermined interruption number into an interruption controller, whereby the interruption controller, after has identified the predetermined interruption number, starts up a privilege upgrading program.

In this step, the operating-system upgrading program writes the predetermined interruption number into the interruption controller, referring to 3 in FIG. 3, wherein the predetermined interruption number and the privilege upgrading program correspond one to one. The interruption controller, after has received the predetermined interruption number, enters the high-level interruption processing mode to execute the privilege upgrading program, referring to 4 in FIG. 3.

The privilege upgrading program is used to upgrade the interruption processing program, and was written into the Flash when the computer left factory. The BIOS, after starting-up, migrates the privilege upgrading program to a fixed position of a fixed privilege-mode address space of the internal memory. The program is provided with a fixed interruption number, i.e., the predetermined interruption number. In the process of the starting-up of the BIOS, the association relation between the predetermined interruption number and the privilege upgrading program is written into the interruption controller; in other words, the interruption controller identifies the predetermined interruption number to temporarily trigger the processor to execute the privilege upgrading program.
S204: by using the privilege upgrading program, acquiring the upgradation parameters from the register of the processor, and according to the upgradation parameters, determining the first position of the new interruption processing program in the physical memory and the second position of the to-be-upgraded interruption processing program in the physical memory.

In this step, after the privilege upgrading program has been executed, the upgradation parameters are obtained from the predetermined CPU register, and, according to the upgradation parameters, the first position of the new interruption processing program in the physical memory, the code length of the new interruption processing program, and the second position of the to-be-upgraded interruption processing program in the physical memory are determined.
S205: by using the privilege upgrading program, migrating the new interruption processing program in the first position to the second position, to replace the to-be-upgraded interruption processing program.

In this step, the privilege upgrading program, according to the code length, migrates the new interruption processing program to the second position of the to-be-upgraded interruption processing program in the physical memory, referring to 5 in FIG. 3. After the upgradation has been completed, the to-be-upgraded interruption processing program in the second position of the physical memory is replaced with the new interruption processing program. The new interruption processing program, because it is in the internal memory, will become effective immediately after the privilege upgrading program has exited. Subsequently, when the interruption corresponding to the interruption processing program is triggered in the OS, the processor is triggered to execute the new interruption processing program.
S206: by using the privilege upgrading program, migrating the new interruption processing program in the first position into a non-volatile memory.

In this step, the privilege upgrading program migrates the new interruption processing program in the first position in the physical memory into the non-volatile memory, referring to 6 in FIG. 3, wherein the non-volatile memory used here may be a BIOS Flash, and the migration position is the position of the to-be-upgraded interruption processing program in the non-volatile memory. In other words, the interruption processing program in the non-volatile memory is replaced by the newest code, to realize non-volatile saving of the interruption processing program, i.e., capable of being saved in powering-down, to ensure that, subsequently, while the system is being started up, in the process of the starting-up of the BIOS, the new interruption processing program in the non-volatile memory is migrated into the physical memory.

Accordingly, it can be seen that the present embodiment realizes the architecture of the upgradation logics of the complete machine, and the operating-system upgrading program, by using the interruption controller, triggers the privilege upgrading program, to upgrade the interruption processing program in the physical memory, and upgrade the interruption processing program in the non-volatile memory. The privilege upgrading program realizes updating of the interruption processing program, wherein the privilege upgrading program firstly upgrades the to-be-upgraded interruption processing program in the physical memory, to ensure the on-line updating of the interruption processing program without shutting-down. The privilege upgrading program upgrades the old interruption processing program in the non-volatile memory, to maintain it to be consistent with that in the physical memory, and realize non-volatile saving of the new interruption processing program.

A program updating apparatus according to the embodiments of the present application will be described below, and the program updating apparatus described below and the program updating method described above may refer to each other.

Referring to FIG. 4, FIG. 4 is a structural diagram of a program updating apparatus according to some illustrative embodiments of the present application. As shown in FIG. 4, the apparatus comprises:

A first migrating module 401 is configured for migrating a new interruption processing program to a physical memory.

The purpose of the present embodiment is to realize updating of the interruption processing program. The interruption processing program according to the present embodiment may be an interruption processing program having the highest processor permission, i.e., a privileged interruption processing program. In this step, the new interruption processing program is migrated to the physical memory.

In a particular implementation, the user may pre-store the new interruption processing program in the magnetic-disk memory, and the processor migrates the new interruption processing program pre-stored in the magnetic-disk memory to the physical memory.

In a particular implementation, the processor migrates the new interruption processing program saved in advance in the magnetic-disk memory by the user to a specific address position of the physical memory of the system, i.e., the first position.

A determining module 402 is configured for acquiring upgradation parameters, and according to the upgradation parameters, determining a first position of the new interruption processing program in the physical memory and a second position of a to-be-upgraded interruption processing program in the physical memory.

In a particular implementation, the processor writes the upgradation parameters into the register, and the upgradation parameters may include the first position of the new interruption processing program in the physical memory, the code length of the new interruption processing program, and the interruption number of the to-be-upgraded interruption processing program. The interruption numbers and to-be-upgraded privileged programs correspond one to one, and are used to determine the position of the to-be-upgraded interruption processing program in the physical memory, i.e., the second position. The upgradation parameters are acquired from the register of the processor, and according to the upgradation parameters, the first position of the new interruption processing program in the physical memory and the second position of the to-be-upgraded interruption processing program in the physical memory are determined.

In a particular implementation, the processor, according to the upgradation parameters, determines the first position of the new interruption processing program in the physical memory; and, according to the interruption number of the to-be-upgraded interruption processing program among the upgradation parameters, determines the second position of the to-be-upgraded interruption processing program in the physical memory.

A second migrating module 403 is configured for migrating the new interruption processing program in the first position to the second position, to replace the to-be-upgraded interruption processing program.

In a particular implementation, the new interruption processing program in the first position in the physical memory is migrated to the second position in the physical memory, so as to replace the to-be-upgraded interruption processing program in the second position in the physical memory with the new interruption processing program.

In a particular implementation, the processor, according to the upgradation parameters, determines the code length of the new interruption processing program, and, according to the code length, migrates the new interruption processing program to the second position in the physical memory.

Because the new interruption processing program is in the internal memory, it becomes effective immediately after the upgrading program has exited, and, subsequently, when the interruption corresponding to the interruption processing program is triggered in the operating system, the processor is triggered to execute the new interruption processing program. In other words, after the operation of migrating the new interruption processing program in the first position to the second position, to replace the to-be-upgraded interruption processing program, the process further comprises: in response to interruption corresponding to an interruption processing program being triggered, triggering a processor to execute the new interruption processing program in the second position.

In a particular implementation, the new interruption processing program in the first position in the physical memory is migrated into the non-volatile memory, wherein the migration position is the position of the to-be-upgraded interruption processing program in the non-volatile memory. In other words, the interruption processing program in the non-volatile memory is replaced by the newest code, to realize non-volatile saving of the interruption processing program, i.e., capable of being saved in powering-down, to ensure that, subsequently, while the system is being started up, in the process of the starting-up of the BIOS, the new interruption processing program in the non-volatile memory is migrated into the physical memory. In other words, after the operation of migrating the new interruption processing program in the first position into the flash memory of the Basic Input Output System, the process further comprises: in response to a processor being restarted, in a process of starting-up of the Basic Input Output System, migrating the new interruption processing program in the non-volatile memory into the physical memory. The non-volatile memory may include a BIOS Flash.

In the program updating apparatus according to the embodiments of the present application, the new interruption processing program is migrated to the position of the to-be-upgraded interruption processing program in the physical memory, and because the new interruption processing program is in the physical memory, it becomes effective immediately after the upgrading program has exited, which realizes updating of the interruption processing program without restarting the system.

On the basis of the above embodiments, as some preferable embodiments of the present application, the first migrating module 401 is particularly configured for:
migrating the new interruption processing program pre-stored in a magnetic-disk memory to the physical memory.

On the basis of the above embodiments, as some preferable embodiments of the present application, the first migrating module 401 is particularly configured for:
migrating the new interruption processing program to the first position in the physical memory.

On the basis of the above embodiments, as some preferable embodiments of the present application, the apparatus further comprises:
a first writing module configured for writing the upgradation parameters into a register of a processor.

On the basis of the above embodiments, as some preferable embodiments of the present application, the determining module 402 is particularly configured for:
acquiring the upgradation parameters from the register of the processor, and according to the upgradation parameters, determining the first position of the new interruption processing program in the physical memory and the second position of the to-be-upgraded interruption processing program in the physical memory.

On the basis of the above embodiments, as some preferable embodiments of the present application, the upgradation parameters include the first position of the new interruption processing program in the physical memory, a code length of the new interruption processing program, and an interruption number of the to-be-upgraded interruption processing program.

On the basis of the above embodiments, as some preferable embodiments of the present application, the determining module 402 is particularly configured for:
acquiring upgradation parameters;
according to the upgradation parameters, determining the first position of the new interruption processing program in the physical memory; and
according to the interruption number of the to-be-upgraded interruption processing program among the upgradation parameters, determining the second position of the to-be-upgraded interruption processing program in the physical memory.

On the basis of the above embodiments, as some preferable embodiments of the present application, the second migrating module 403 is particularly configured for:
according to the code length of the new interruption processing program among the upgradation parameters, migrating the new interruption processing program in the first position to the second position.

On the basis of the above embodiments, as some preferable embodiments of the present application, the apparatus further comprises:
a triggering module configured for, in response to interruption corresponding to an interruption processing program being triggered, triggering a processor to execute the new interruption processing program in the second position.

On the basis of the above embodiments, as some preferable embodiments of the present application, the apparatus further comprises:
a third migrating module configured for migrating the new interruption processing program in the first position into a non-volatile memory.

On the basis of the above embodiments, as some preferable embodiments of the present application, the third migrating module is particularly configured for:
migrating the new interruption processing program in the first position into a flash memory of a Basic Input Output System.

On the basis of the above embodiments, as some preferable embodiments of the present application, the apparatus further comprises:
a fourth migrating module configured for, in response to a processor being restarted, in a process of starting-up of the Basic Input Output System, migrating the new interruption processing program in the non-volatile memory into the physical memory.

On the basis of the above embodiments, as some preferable embodiments of the present application, the interruption processing program includes an interruption processing program having a highest processor permission.

On the basis of the above embodiments, as some preferable embodiments of the present application, the first migrating module 401 is particularly configured for:
by using an operating-system upgrading program, migrating the new interruption processing program to the physical memory.

In the present embodiment, the operating-system upgrading program serves to initiate the updating process. Firstly, the operating-system upgrading program migrates the new interruption processing program saved in advance in the magnetic-disk memory by the user to a specific address position of the physical memory of the system, i.e., the first position.

On the basis of the above embodiments, as some preferable embodiments of the present application, the first writing module is particularly configured for:
by using the operating-system upgrading program, writing the upgradation parameters into a register of a processor.

In a particular implementation, the operating-system upgrading program writes the upgradation parameters into the CPU register. The upgradation parameters may include the first position of the new interruption processing program in the physical memory, the code length of the new interruption processing program, and the interruption number of the to-be-upgraded interruption processing program. The interruption numbers and to-be-upgraded privileged programs correspond one to one, and are used to determine the position of the to-be-upgraded interruption processing program in the physical memory, i.e., the second position.

On the basis of the above embodiments, as some preferable embodiments of the present application, the apparatus further comprises:
a second writing module configured for, by using the operating-system upgrading program, writing a predetermined interruption number into an interruption controller, whereby the interruption controller, after has identified the predetermined interruption number, starts up a privilege upgrading program.

In a particular implementation, the operating-system upgrading program writes the predetermined interruption number into the interruption controller, wherein the predetermined interruption number and the privilege upgrading program correspond one to one. The interruption controller, after has received the predetermined interruption number, enters the high-level interruption processing mode to execute the privilege upgrading program.

The privilege upgrading program is used to upgrade the interruption processing program, and was written into the Flash when the computer left factory. The BIOS, after starting-up, migrates the privilege upgrading program to a fixed position of a fixed privilege-mode address space of the internal memory. The program is provided with a fixed interruption number, i.e., the predetermined interruption number. In the process of the starting-up of the BIOS, the association relation between the predetermined interruption number and the privilege upgrading program is written into the interruption controller; in other words, the interruption controller identifies the predetermined interruption number to temporarily trigger the processor to execute the privilege upgrading program.

On the basis of the above embodiments, as some preferable embodiments of the present application, the determining module 402 is particularly configured for:
by using the privilege upgrading program, acquiring the upgradation parameters from the register of the processor, and according to the upgradation parameters, determining the first position of the new interruption processing program in the physical memory and the second position of the to-be-upgraded interruption processing program in the physical memory.

In a particular implementation, after the privilege upgrading program has been executed, the upgradation parameters are obtained from the predetermined CPU register, and, according to the upgradation parameters, the first position of the new interruption processing program in the physical memory, the code length of the new interruption processing program, and the second position of the to-be-upgraded interruption processing program in the physical memory are determined.

On the basis of the above embodiments, as some preferable embodiments of the present application, the second migrating module 403 is particularly configured for:
by using the privilege upgrading program, migrating the new interruption processing program in the first position to the second position, to replace the to-be-upgraded interruption processing program.

In a particular implementation, the privilege upgrading program, according to the code length, migrates the new interruption processing program to the second position of the to-be-upgraded interruption processing program in the physical memory. After the upgradation has been completed, the to-be-upgraded interruption processing program in the second position of the physical memory is replaced with the new interruption processing program. The new interruption processing program, because it is in the internal memory, will become effective immediately after the privilege upgrading program has exited. Subsequently, when the interruption corresponding to the interruption processing program is triggered in the OS, the processor is triggered to execute the new interruption processing program.

On the basis of the above embodiments, as some preferable embodiments of the present application, the third migrating module is particularly configured for:
by using the privilege upgrading program, migrating the new interruption processing program in the first position into a non-volatile memory.

In a particular implementation, the privilege upgrading program migrates the new interruption processing program in the first position in the physical memory into the non-volatile memory, wherein the non-volatile memory used here may be a BIOS Flash, and the migration position is the position of the to-be-upgraded interruption processing program in the non-volatile memory. In other words, the interruption processing program in the non-volatile memory is replaced by the newest code, to realize non-volatile saving of the interruption processing program, i.e., capable of being saved in powering-down, to ensure that, subsequently, while the system is being started up, in the process of the starting-up of the BIOS, the new interruption processing program in the non-volatile memory is migrated into the physical memory.

Accordingly, it can be seen that the present embodiment realizes the architecture of the upgradation logics of the complete machine, and the operating-system upgrading program, by using the interruption controller, triggers the privilege upgrading program, to upgrade the interruption processing program in the physical memory, and upgrade the interruption processing program in the non-volatile memory. The privilege upgrading program realizes updating of the interruption processing program, wherein the privilege upgrading program firstly upgrades the to-be-upgraded interruption processing program in the physical memory, to ensure the on-line updating of the interruption processing program without shutting-down. The privilege upgrading program upgrades the old interruption processing program in the non-volatile memory, to maintain it to be consistent with that in the physical memory, and realize non-volatile saving of the new interruption processing program.

The particular modes of the operations performed by the modules of the apparatus according to the above embodiments have already been described in detail in the embodiments of the method, and will not be explained and described in detail herein.

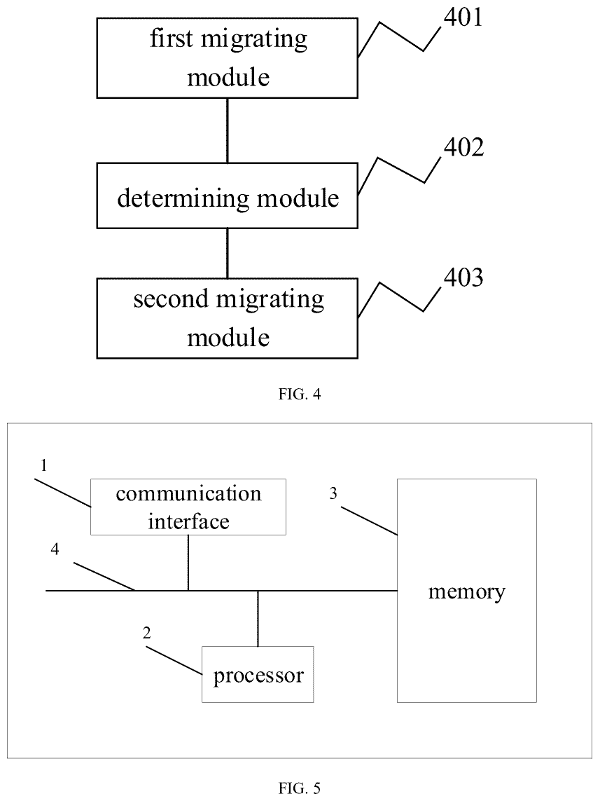

On the basis of the hardware embodying of the above-described program modules, and in order to implement the method according to the embodiments of the present application, an embodiment of the present application further provides an electronic device. FIG. 5 is a structural diagram of an electronic device according to some illustrative embodiments of the present application. As shown in FIG. 5, the electronic device comprises:
a communication interface 1 capable of performing information interaction with other devices such as a network device; and
a processor 2 connected to the communication interface 1 to implement the information interaction with the other devices, and configured for, when executing a computer program, implementing the program updating method according to one or more technical solutions stated above. Moreover, the computer program is stored in a memory 3.

Certainly, in practical applications, the components in the electronic device are coupled together by a bus system 4. It can be understood that the bus system 4 is configured for implementing the connection and communication between the components. The bus system 4 does not only comprise a data bus, but also comprises a power-supply bus, a controlling bus and a state-signal bus. However, in order for clarity of the description, in FIG. 5 all of the various buses are marked as the bus system 4.

The memory 3 according to the embodiments of the present application stores various types of data to support the operations in the electronic device. Examples of those data include any computer program configured for operating in the electronic device.

It can be understood that the memory 3 may be a volatile memory or a non-volatile memory, and may also comprise both of a volatile memory and a non-volatile memory. The non-volatile memory may be a Read-Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a Flash Memory, a magnetic surface memory, an optical disk, or a Compact Disc Read-Only Memory (CD-ROM). The magnetic surface memory may be a magnetic-disk memory or a magnetic-tape memory. The volatile memory may be a Random Access Memory (RAM), and is used as an external high-speed buffer. As exemplary but not limiting examples, RAMs in many forms are usable, for example, a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a SyncLink Dynamic Random Access Memory (SLDRAM) and a Direct Rambus Random Access Memory (DRRAM). The memory 3 according to the embodiments of the present application is intended to include but be not limited to those and any other suitable types of memories.

The method according to the embodiments of the present application may be applied in the processor 2, or be implemented by the processor 2. The processor 2 may be an integrated-circuit chip, and has the capacity of signal processing. In implementations, the steps of the above-described method may be completed by using an integrated logic circuit of the hardware or an instruction in the form of software of the processor 2. The processor 2 may be a generic processor, a DSP (Digital Signal Processor), or another programmable logic device, discrete gate or transistor logic device, or discrete hardware component, and so on. The processor 2 may implement or execute the methods, the steps and the logic block diagrams according to the embodiments of the present application. The generic processor may be a microprocessor or any conventional processor. The steps of the method according to the embodiments of the present application may be directly embodied as executed by a hardware decoding processor, or executed by a combination between hardware in the decoding processor and a software module. The software module may exist in a storage medium. The storage medium exists in the memory 3, and the processor 2 reads the program in the memory 3, and cooperates with its hardware to implement the steps of the method stated above.

The processor 2, when executing the program, implements the corresponding processes of the methods according to the embodiments of the present application, which, in order for brevity, is not discussed further herein.

In an illustrative embodiment, an embodiment of the present application further provides a storage medium, i.e., a computer storage medium, which is particularly a non-volatile readable storage medium, for example, including the memory 3 storing a computer program. The computer program may be executed by the processor 2, to complete the steps of the method stated above. The non-volatile readable storage medium may be memories such as FRAM, ROM, PROM, EPROM, EEPROM, Flash Memory, a magnetic surface memory, an optical disk and a CD-ROM.

A person skilled in the art can understand that all or some of the steps of the above process embodiments may be implemented by relative hardware according to an instruction from a program, the program may be stored in a non-volatile readable storage medium, and the program, when executed, implements the steps of the above process embodiments. Moreover, the above storage medium includes various media that can store a program code, such as a mobile storage device, an ROM, an RAM, a diskette and an optical disk.

Alternatively, the integrated units according to the present application, if embodied in the form of a software function module and sold or used as an independent product, may be stored in a non-volatile readable storage medium. On the basis of such a comprehension, the substance of the technical solutions of the embodiments of the present application, or the part thereof that makes a contribution over the prior art, may be embodied in the form of a software product. The computer software product is stored in a non-volatile readable storage medium, and contains multiple instructions configured so that an electronic device (which may be a personal computer, a server, a network device and so on) implements the whole or part of the methods according to the embodiments of the present application. Moreover, the above storage medium includes various media that can store a program code, such as a mobile storage device, an ROM, an RAM, a diskette and an optical disk.

The above are merely particular embodiments of the present application, and the protection scope of the present application is not limited thereto. All of the variations or substitutions that a person skilled in the art can easily envisage within the technical scope disclosed by the present application should fall within the protection scope of the present application. Therefore, the protection scope of the present application should be subject to the protection scope of the claims.

1. A program updating method, wherein the method is applied in a computer system, the computer system comprises a processor, a magnetic-disk memory, a physical memory and a non-volatile memory, and the method comprises:
migrating a new interruption processing program pre-stored in the magnetic-disk memory to a first position of the physical memory;
acquiring upgradation parameters from a register of the processor, and according to the upgradation parameters, determining a first position of the new interruption processing program in the physical memory and a second position of a to-be-upgraded interruption processing program in the physical memory;
migrating the new interruption processing program in the first position to the second position, to replace the to-be-upgraded interruption processing program; and
migrating the new interruption processing program in the first position to the non-volatile memory.

2. (canceled)

3. (canceled)

4. The program updating method according to claim 1, wherein after the step of migrating the new interruption processing program to the physical memory, the method further comprises:
writing the upgradation parameters into the register of the processor.

5. (canceled)

6. The program updating method according to claim 1, wherein the upgradation parameters include the first position of the new interruption processing program in the physical memory, a code length of the new interruption processing program, and an interruption number of the to-be-upgraded interruption processing program.

7. The program updating method according to claim 6, wherein the step of, according to the upgradation parameters, determining the first position of the new interruption processing program in the physical memory and the second position of the to-be-upgraded interruption processing program in the physical memory comprises:
according to the upgradation parameters, determining the first position of the new interruption processing program in the physical memory; and
according to the interruption number of the to-be-upgraded interruption processing program among the upgradation parameters, determining the second position of the to-be-upgraded interruption processing program in the physical memory.

8. The program updating method according to claim 6, wherein the step of migrating the new interruption processing program in the first position to the second position comprises:
according to the code length of the new interruption processing program among the upgradation parameters, migrating the new interruption processing program in the first position to the second position.

9. The program updating method according to claim 1, wherein after the step of migrating the new interruption processing program in the first position to the second position, to replace the to-be-upgraded interruption processing program, the method further comprises:
in response to interruption corresponding to an interruption processing program being triggered, triggering a processor to execute the new interruption processing program in the second position.

10. (canceled)

11. The program updating method according to claim 1, wherein the step of migrating the new interruption processing program in the first position into the non-volatile memory comprises:
migrating the new interruption processing program in the first position into a flash memory of a Basic Input Output System.

12. The program updating method according to claim 1, wherein after the step of migrating the new interruption processing program in the first position into the flash memory of the Basic Input Output System, the method further comprises:
in response to a processor being restarted, in a process of starting-up of the Basic Input Output System, migrating the new interruption processing program in the non-volatile memory into the physical memory.

13. The program updating method according to claim 1, wherein the interruption processing program includes an interruption processing program having a highest processor permission.

14. The program updating method according to claim 1, wherein the step of migrating the new interruption processing program pre-stored in the magnetic-disk memory to the first position of the physical memory comprises:
by using an operating-system upgrading program, migrating the new interruption processing program pre-stored in the magnetic-disk memory to the first position of the physical memory.

15. The program updating method according to claim 14, wherein after the step of, by using the operating-system upgrading program, migrating the new interruption processing program pre-stored in the magnetic-disk memory to the first position of the physical memory, the method further comprises:
by using the operating-system upgrading program, writing the upgradation parameters into a register of a processor.

16. The program updating method according to claim 15, wherein after the step of, by using the operating-system upgrading program, writing the upgradation parameters into the register of the processor, the method further comprises:
by using the operating-system upgrading program, writing a predetermined interruption number into an interruption controller, whereby the interruption controller, after has identified the predetermined interruption number, starts up a privilege upgrading program.

17. The program updating method according to claim 16, wherein the step of acquiring the upgradation parameters from the register of the processor, and according to the upgradation parameters, determining the first position of the new interruption processing program in the physical memory and the second position of the to-be-upgraded interruption processing program in the physical memory comprises:
by using the privilege upgrading program, acquiring the upgradation parameters from the register of the processor, and according to the upgradation parameters, determining the first position of the new interruption processing program in the physical memory and the second position of the to-be-upgraded interruption processing program in the physical memory.

18. The program updating method according to claim 17, wherein the step of migrating the new interruption processing program in the first position to the second position, to replace the to-be-upgraded interruption processing program comprises:
by using the privilege upgrading program, migrating the new interruption processing program in the first position to the second position, to replace the to-be-upgraded interruption processing program.

19. The program updating method according to claim 18, wherein after the step of, by using the privilege upgrading program, migrating the new interruption processing program in the first position to the second position, to replace the to-be-upgraded interruption processing program, the method further comprises:
by using the privilege upgrading program, migrating the new interruption processing program in the first position into the non-volatile memory.

20. (canceled)

21. An electronic device, wherein the electronic device comprises:
a memory configured for storing a computer program; and
a processor configured for, when executing the computer program, implementing the steps of the program updating method according to claim 1.

22. A non-transitory readable storage medium, wherein the non-transitory readable storage medium stores a computer program, and the computer program, when executed by a processor, implements the steps of the program updating method according to claim 1.
